(19) United States
(12) Patent Application Publication
(10) Pub. No.: US 2011/0305893 A1
(43) Pub. Date: Dec. 15, 2011

(54) ALUMINUM ALLOY-AND-RESIN COMPOSITE AND METHOD FOR MAKING THE SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); PO-CHUAN WU, Tu-Cheng (TW); DAI-YU SUN, Shenzhen City (CN); YUAN-YUAN FENG, Shenzhen City, Guangdong Province (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/087,508

(22) Filed: Apr. 15, 2011

(30) Foreign Application Priority Data
Jun. 10, 2010 (CN) 201010197108.6
Mar. 11, 2011 (CN) 201110058897.X

(51) Int. Cl. B32B 3/26; B29C 45/14; B29C 67/20

(52) U.S. Cl. 428/322.7; 264/414

(57) ABSTRACT

An aluminum alloy-and-resin composite includes an aluminum alloy substrate and resin composition formed on the substrate. The substrate is subjected to electrochemically etched and formed with nano-pores on its surface. The resin composition integrally couples to the surface of the aluminum alloy substrate by filling the nano-pores. The resin composition contains crystalline thermoplastic synthetic resins.

### CROSS-REFERENCE TO RELATED APPLICATIONS

This application is one of the two related co-pending U.S. patent applications listed below. All listed applications have the same assignee. The disclosure of each of the listed applications is incorporated by reference into another listed application.

| Attorney | | |
|---|---|---|
| Docket No. | Title | Inventors |
| US 33056 | ALUMINUM ALLOY-AND-RESIN | WEN-RONG |
| | COMPOSITE AND METHOD FOR | CHEN et al. |
| | MAKING THE SAME | |
| US 33709 | ALUMINUM ALLOY-AND-RESIN | WEN-RONG |
| | COMPOSITE AND METHOD FOR | CHEN et al. |
| | MAKING THE SAME | |

### BACKGROUND

1. Technical Field

The present disclosure relates to aluminum alloy-and-resin composites, particularly to an aluminum alloy-and-resin composite having high bonding strength between aluminum alloy and resin and a method for making the composite.

2. Description of Related Art

Adhesives, for combining heterogeneous materials in the form of a metal (such as light metals) and a synthetic resin are demanded in a wide variety of technical fields and industries, such as the automotive and household appliance fields. However, adhesives are generally only effective in a narrow temperature range of about −50° C. to about 100° C., which means they are not suitable in applications where operating or environmental temperatures may fall outside the range.

Therefore, other bonding methods have been applied that do not involve the use of an adhesive. One example of such methods is by forming bonds through injection molding or other similar process. However, the bonding strength of the metal and resin can be further improved.

Therefore, there is room for improvement within the art.

### BRIEF DESCRIPTION OF THE FIGURES

Many aspects of the aluminum alloy-and-resin composite can be better understood with reference to the following figures. The components in the figures are not necessarily drawn to scale, the emphasis instead being placed upon clearly illustrating the principles of the aluminum alloy-and-resin composite. Moreover, in the drawings like reference numerals designate corresponding parts throughout the several views.

FIG. 1 is a cross-section view of an exemplary embodiment of a composite of electrochemically etched aluminum alloy and resin.

FIG. 2 is a scanning electron microscopy view of an exemplary embodiment of the electrochemically etched aluminum alloy.

FIG. 3 is a cross-section view of molding the composite shown in FIG. 1.

### DETAILED DESCRIPTION

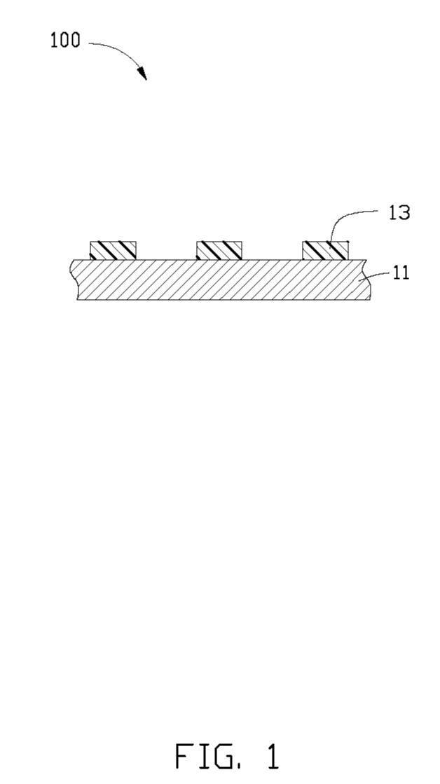

FIG. 1 shows an aluminum alloy-and-resin composite 100 according to an exemplary embodiment. The aluminum alloy-and-resin composite 100 includes an aluminum alloy substrate 11 and resin compositions 13 formed on the substrate 11.

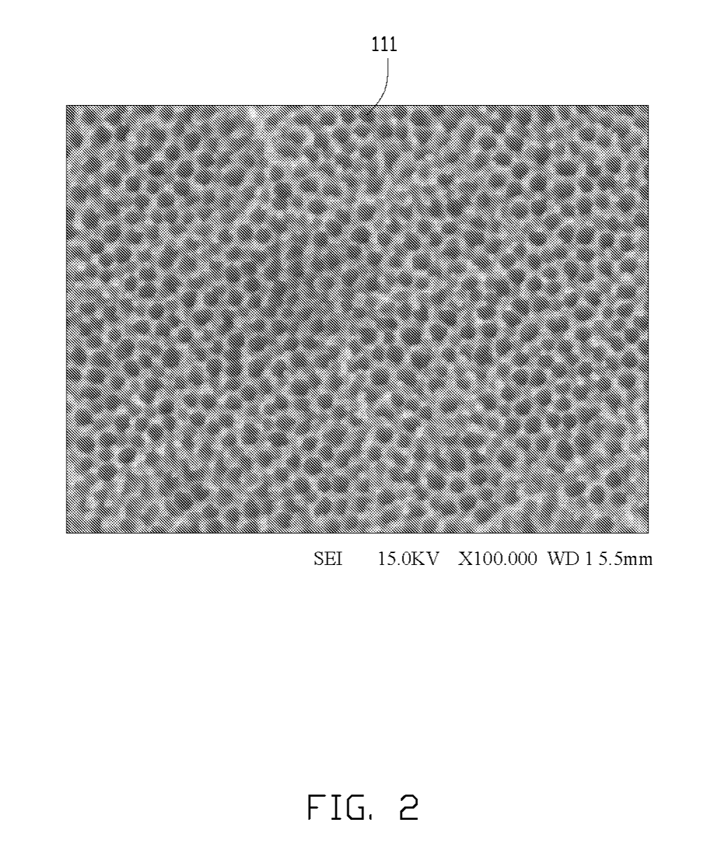

Referring to FIG. 2, the substrate 11 defines nano-pores 111. These nano-pores 111 have an average diameter of 20-60 nm. The nano-pores 111 may be evenly distributed on the substrate 11. The surface roughness (Ra) of the substrate 11 is about 0.1-1 μm. The nano-pores 111 may be formed by electrochemically etching the substrate 11. An energy dispersive spectrometer (EDS) test indicates that no alumina or other oxide film forms on the surface of the substrate 11 after the substrate 11 is electrochemically etched.

The resin compositions 13 may be coupled to the surface of the substrate 11 having the nano-pores 111 by molding. During the molding process, molten resin coats the surface of the substrate 11 and fills the nano-pores 111, thus strongly bonding the resin compositions 13 to the substrate 11. Compared to the conventional injection molding process in which the aluminum alloy substrate is not electrochemically etched, the composite 100 in this exemplary embodiment has a much stronger bond between the resin compositions 13 and the substrate 11 (about quintuple the bonding force). The resin compositions 13 may be made up of crystalline thermoplastic synthetic resins having high fluidity. In this exemplary embodiment, polyphenylene sulfide (PPS) and polyamide (PA) can be selected as the molding materials for the resin compositions 13. These resin compositions 13 can bond firmly with the substrate 11.

It is to be understood that auxiliary components may be added to the resins to modify properties of the resin compositions 13, for example, fiberglass may be added to PPS. The fiberglass may have a mass percentage of about 30%.

A method for making the composite 100 may include the following steps:

The aluminum alloy substrate 11 is provided.

The substrate 11 is degreased. The degreasing process may include the step of dipping the substrate 11 in a sodium salt water solution for about 5-15 minutes. The sodium salt solution may include sodium carbonate having a concentration of about 30-50 grams per liter (g/L), sodium phosphate having a concentration of about 30-50 g/L, and sodium silicate having a concentration of about 3-5 g/L. The temperature of the sodium salt solution may be about 50-60° C. Once degreased, the substrate 11 is removed from the sodium salt solution and rinsed in water.

The surface of the substrate 11 is smoothened. The smoothening of the substrate 11 may include the step of alkaline eroding. The alkaline eroding process may include the step of dipping the substrate 11 in an alkaline water solution for about 3-5 minutes. The alkaline solution may include sodium hydroxide having a concentration of about 10-50 g/L. The alkaline eroding process smoothes the surface of the substrate 11 so that the smoothed surface of the substrate 11 will be more uniformly electrochemically etched to obtain a narrower range of diameters of the nano-pores 111 of the substrate 11. Next, the substrate 11 is removed from the alkaline solution and rinsed in water.

The substrate 11 is electrochemically etched to form the nano-pores 111. The electrochemical etching process may be carried out in an acid water solution containing sulfuric acid and phosphoric acid, with the substrate 11 being an anode, and a stainless steel board or a lead plate being a cathode. The sulfuric acid may have a concentration of about 30-50 ml/L, and the phosphoric acid may have a concentration of about 20-60 ml/L. The electric current density through the acid solution is about 2-4 ampere per square decimeter (A/dm²). Electrochemical etching the substrate 11 may last for about 8-15 minutes, which is considerably less time and more effective than an anodizing process (about 20-60 minutes) for forming nano-pores. Next, the substrate 11 is rinsed in water and then dried.

During the electrochemical etching process, Al on the surface of the substrate 11 loses electrons to form aluminum ions in the acid solution (Al-3e=Al³⁺), as such, the substrate 11 is etched and nano-pores 111 are formed.

In the exemplary embodiment, the electrochemical etching process is substantially different from the anodizing process for aluminum alloy, which is substantially the process of forming alumina having nano-pores on the aluminum alloy.

Furthermore, compared to conventional chemical etching process, the electrochemical etching process in the exemplary embodiment is effective in forming nano-pores in the substrate 11, and the nano-pores 111 are of a more uniform shape, with a narrow range of diameters, and are evenly distributed in the substrate 11.

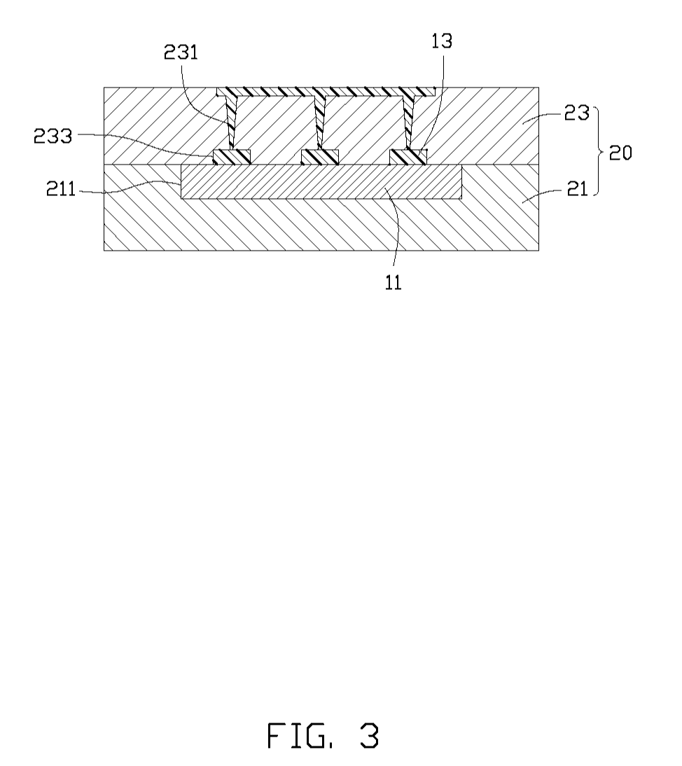

Referring to FIG. 3, an injection mold 20 is provided. The injection mold 20 includes a core insert 23 and a cavity insert 21. The core insert 23 defines several gates 231, and several first cavities 233. The cavity insert 21 defines a second cavity 211 for receiving the substrate 11. The electrochemically etched substrate 11 is located in the second cavity 211, and molten resin is injected through the gates 231 to coat the surface of the substrate 11 and fill the nano-pores 111, and finally fill the first cavities 233 to form the resin compositions 13, as such, the composite 100 is formed. The molten resin may be crystalline thermoplastic synthetic resins having high fluidity, such as PPS, or PA. During the molding process, the injection mold 20 may be at a temperature of about 120-140° C.

Tensile strength and shear strength of the composite 100 have been tested. The tests indicate that the tensile strength of the composite 100 is greater than 10 MPa, and the shear strength of the composite 100 is greater than 20 MPa. Furthermore, the composite 100 has been subjected to a temperature humidity bias test (72 hours, 85° C., relative humidity: 85%) and a thermal shock test (48 hours, −40˜85° C., 4 hours/cycle, 12 cycles total), such testing did not result in decreased tensile strength and shear strength of the composite 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An aluminum alloy-and-resin composite, comprising:
an aluminum alloy substrate electrochemically etched to form nano-pores on a surface thereof; and
at least a resin composition integrally coupled to the surface of the aluminum alloy substrate having the nano-pores, the resin composition filling the nano-pores and containing crystalline thermoplastic synthetic resins.

2. The composite as claimed in claim 1, wherein the nano-pores have an average diameter of about 20-60 nm.

3. The composite as claimed in claim 2, wherein the surface of the substrate has a surface roughness (Ra) of about 0.1-1 μm.

4. The composite as claimed in claim 1, wherein the surface of the substrate is formed with no alumina or oxide film on its surface.

5. The composite as claimed in claim 1, wherein the resin composition is formed by molding crystalline thermoplastic synthetic resin on the substrate.

6. The composite as claimed in claim 5, wherein the crystalline thermoplastic synthetic resin is polyphenylene sulfide or polyamide.

7. The composite as claimed in claim 6, wherein the crystalline thermoplastic synthetic resin is polyphenylene sulfide added with fiberglass, the fiberglass has a mass percentage of about 30%.

8. A method for making an aluminum alloy-and-resin composite, comprising:
providing an aluminum alloy substrate;
electrochemical etching the substrate to form nano-pores on a surface thereof; and
inserting the substrate in a mold and molding crystalline thermoplastic synthetic resin on the surface having the nano-pores and filling the nano-pores to form the composite.

9. The method as claimed in claim 8, wherein the nano-pores have an average diameter of about 20-60 nm.

10. The method as claimed in claim 9, wherein said surface of the substrate has a surface roughness (Ra) of about 0.1-1 μm, and is formed with no alumina or oxide film on its surface.

11. The method as claimed in claim 8, wherein electrochemical etching the substrate is carried out in an acid water solution containing sulfuric acid and phosphoric acid for about 8-15 minutes, the concentration of the sulfuric acid is about 30-50 ml/L, the concentration of the phosphoric acid is about 20-60 ml/L, the electric current density through the acid solution is about 2-4 A/dm².

12. The method as claimed in claim 11, wherein the substrate is used as an anode during the electrochemically etching process, and Al on the surface of the substrate loses electrons to form aluminum ions in the acid water solution.

13. The method as claimed in claim 8, wherein the crystalline thermoplastic synthetic resin is polyphenylene sulfide or polyamide.

14. The method as claimed in claim 13, wherein the crystalline thermoplastic synthetic resin is polyphenylene sulfide added with fiberglass, the fiberglass has a mass percentage of about 30%.

15. The method as claimed in claim 8, further comprising a step of smoothening the surface of the substrate before electrochemical etching the substrate.

16. The method as claimed in claim 15, wherein smoothening the substrate comprising a step of alkaline eroding the substrate.

17. The method as claimed in claim 16, wherein alkaline eroding the substrate comprising the step of dipping the substrate in a sodium hydroxide water solution having a concentration of about 10-50 g/L for about 3-5 minutes.

18. The method as claimed in claim 15, further comprising a step of degreasing the substrate before smoothening the substrate.

19. An aluminum alloy-and-resin composite, comprising:
an aluminum alloy substrate subjected to electrochemically etched to form nano-pores on the surface thereof; and
at least a resin composition integrally molded to the surface of the aluminum alloy substrate having the nano-pores and filling the nano-pores, the resin composition containing crystalline thermoplastic synthetic resins.
